(19) United States
(12) Patent Application Publication
(10) Pub. No.: US 2021/0109279 A1
(43) Pub. Date: Apr. 15, 2021

(54) ADVERTISING DISPLAY DEVICE

(71) Applicant: LITEMAX ELECTRONICS INC., New Taipei City (TW)

(72) Inventors: Chun-Hung Chen, NEW TAIPEI CITY (TW); Chin-Chen Liu, NEW TAIPEI CITY (TW); Shang-Wei Liu, NEW TAIPEI CITY (TW)

(21) Appl. No.: 16/680,694

(22) Filed: Nov. 12, 2019

(30) Foreign Application Priority Data
Oct. 14, 2019 (TW) 108136863

(51) Int. Cl. F21V 8/00; G09F 13/18

(52) U.S. Cl. CPC G02B 6/0095; G02B 6/0055; G09F 2013/1831; G02B 6/0073; G09F 13/18; G02B 6/0088

(57) ABSTRACT

An advertising display device includes a base body, a light-guiding unit, a light-emitting unit and an audio and video output unit. Therefore, the audio and video output unit plays the advertising film, and the light-emitting unit carries out the demonstration of the light source in conjunction with the light-guiding unit at the time of playing the advertising film to increase visual effects and attract the attention of consumers for achieving a better advertising effectiveness.

### CROSS-REFERENCE TO RELATED APPLICATION

This non-provisional application claims priority under 35 U.S.C. § 119(a) on Patent Application No(s). 108136863 filed in Taiwan, R.O.C. on Oct. 14, 2019, the entire contents of which are hereby incorporated by reference.

### BACKGROUND OF THE INVENTION

### 1. Field of the Invention

The present disclosure relates to an advertising display device, and in particular to an advertising display device which can carry out the demonstration of the light source at the time of playing the advertising film to increase visual effects and attract the attention of consumers for achieving a better advertising effectiveness.

### 2. Description of the Related Art

It is found that a common advertising display device is a display that is often provided on a surface of a wall, and it can achieve an advertising effectiveness by the display going with a video player to play an advertising film.

However, in the case of a traditional advertising display device, the display fails to have any design for attracting the attention of consumers other than playing an advertising film so that the consumers often ignore the advertising film that is played by the display, resulting in a limited effect.

Therefore, it will be the present invention want to actively disclose how to invent an advertising display device which can carry out the demonstration of the light source at the time of playing the advertising film to increase visual effects and attract the attention of consumers for achieving a better advertising effectiveness in order to effectively improve the shortcomings of the prior art.

### BRIEF SUMMARY OF THE INVENTION

An objective of the present disclosure is to provide an advertising display device, and in particular to an advertising display device which can carry out the demonstration of the light source at the time of playing the advertising film to increase visual effects and attract the attention of consumers for achieving a better advertising effectiveness. In view of the shortcomings of the above-mentioned prior art. the inventor felt that it was not perfect, and exhausted his mind to research carefully into a way for overcoming the problems, and then developed the advertising display device.

To achieve at least the above objective, the present disclosure provides an advertising display device which comprises a base body, a light-guiding unit, a light-emitting unit and an audio and video output unit. The base body includes a base and a closed plate provided on a surface of the base; the light-guiding unit is provided on the closed plate, and the light-guiding unit includes a reflective film provided on a surface of the closed plate, a light-guiding plate provided on a surface of the reflective film, and a light-transmission cover plate provided on a surface of the light-guiding plate; the light-emitting unit includes at least one first light-emitting body provided on an outer edge of the light-guiding plate; the audio and video output unit is provided between the base and the closed plate, and the closed plate, the reflective film, the light-guiding plate and the light-transmission cover plate respectively have a window area corresponding to the audio and video output unit.

In an embodiment of the advertising display device, the base is equipped with at least two handles on the other surface thereof, and the base is equipped with a plurality of perforations on the other surface thereof.

In an embodiment of the advertising display device, the light-emitting unit is further equipped with a second light-emitting body, and the second light-emitting body is provided on an inner edge of the light-guiding plate.

In an embodiment of the advertising display device, the light-emitting unit is further equipped with a second light-emitting body, the light-guiding plate is equipped with a pattern portion at the bottom, and the second light-emitting body is provided on an inner edge of the light-guiding plate.

In an embodiment of the advertising display device, the light-emitting unit is further equipped with a second light-emitting body, and another light-guiding plate is provided between the light-guiding plate and the reflective film, the another light-guiding plate is equipped with a pattern portion at the bottom, the second light-emitting body is provided on an inner edge of the another light-guiding plate.

In an embodiment of the advertising display device, the audio and video output unit includes a display and a video player connected to the display, and the window areas correspond to the video player.

In an embodiment of the advertising display device, the first light-emitting body is a LED light strip provided annularly on the outer edge of the light-guiding plate, and the first light-emitting body is connected to a light source controller.

In an embodiment of the advertising display device, the second light-emitting body is a LED light strip provided annularly on the inner edge of the light-guiding plate, and the second light-emitting body is connected to a light source controller.

In an embodiment of the advertising display device, the reflective film is equipped with a pattern portion thereon.

Therefore, the advertising display device of the invention provides that the audio and video output unit plays the advertising film, and the light-emitting unit carries out the demonstration of the light source in conjunction with the light-guiding unit at the time of playing the advertising film to increase visual effects and attract the attention of consumers for achieving a better advertising effectiveness.

### BRIEF DESCRIPTION OF THE DRAWINGS

FIG. 1 is a schematic external view according to a first embodiment of the present disclosure.

FIG. 2 is a schematic exploded view according to the first embodiment of the present disclosure.

FIG. 3 is a schematic view of the sectional state according to the first embodiment of the present disclosure.

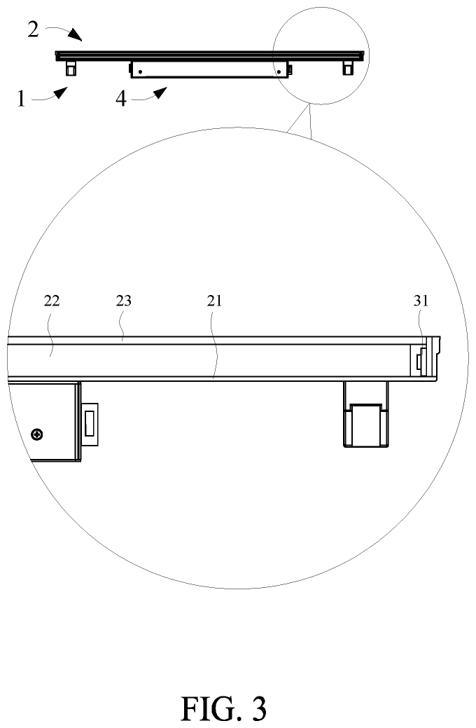

FIG. 4 is a schematic exploded view according to a second embodiment of the present disclosure.

FIG 5 is a schematic view of the sectional state according to the second embodiment of the present disclosure.

FIG. 6 is a schematic exploded view according to a third embodiment of the present disclosure.

FIG. 7 is a schematic view of the sectional state according to the third embodiment of the present disclosure.

FIG. 8 is a schematic exploded view according to a fourth embodiment of the present disclosure.

FIG. 9 is a schematic view of the sectional state according to the fourth embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

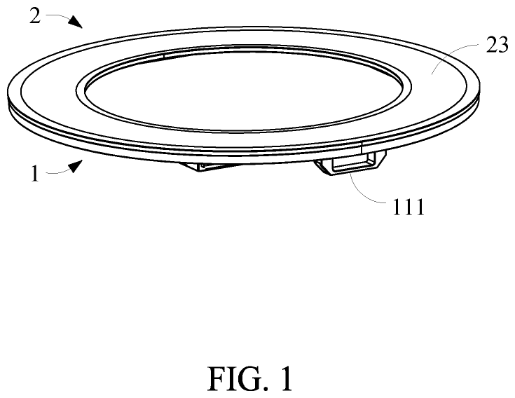

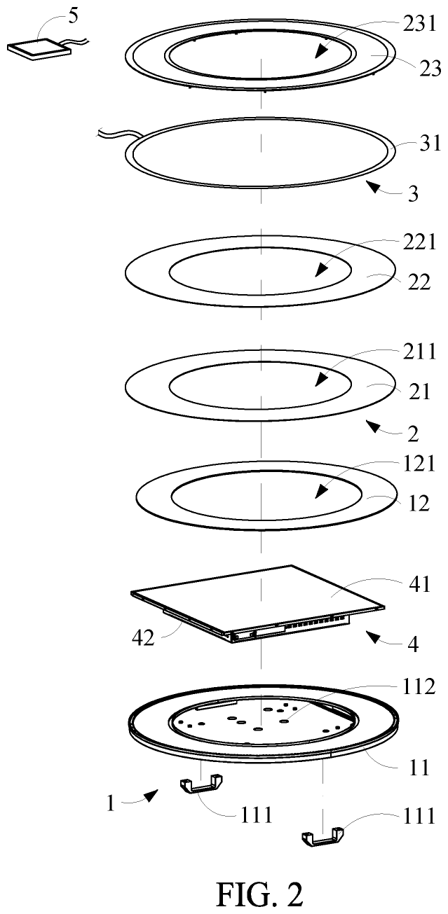

Referring to FIGS. 1 to 2, as shown in the drawings, the invention is an advertising display device which comprises a base body 1, a light-guiding unit 2, a light-emitting unit 3 and an audio and video output unit 4.

The base body 1 includes a base 11 and a closed plate 12 provided on a surface of the base 11.

The light-guiding unit 2 is provided on the closed plate 12, and the light-guiding unit 2 includes a reflective film 21 provided on a surface of the closed plate 12, a light-guiding plate 22 provided on a surface of the reflective film 21, and a light-transmission cover plate 23 provided on a surface of the light-guiding plate 22.

The light-emitting unit 3 includes at least one first light-emitting body 31 provided on an outer edge of the light-guiding plate 22.

The audio and video output unit 4 is provided between the base 11 and the closed plate 12, and the closed plate 12, the reflective film 21, the light-guiding plate 22 and the light-transmission cover plate 23 respectively have a window area 121, 211, 221, 231 corresponding to the audio and video output unit 4.

When the invention is in use, the base body 1 may be mounted on a surface of a wall, a stand or other bracket, the audio and video output unit 4 is used to play a required advertising film, and the advertising film is presented by the window areas 121, 211, 221, 231. Also, when the advertising film is played, the light source can be emitted by the first light-emitting body 31 of the light-emitting unit 3 so that the light source of the first light-emitting body 31 is introduced inward from the outer edge of the light-guiding plate 22, and the light source of the first light-emitting body 31 is radiated from a direction of the light-transmission cover plate 23 after the light source is transmitted by the light-guiding plate 22 because of the installation of the reflective film 21, and thus the first light-emitting body 31 can go with the advertising film played by the audio and video output unit 4 to carry out the demonstration of the light source. Accordingly, the advertising film can be played by the audio and video output unit 4, and the light-emitting unit 3 carries out the demonstration of the light source in conjunction with the light-guiding unit 2 at the time of playing the advertising film to increase visual effects and attract the attention of consumers for achieving a better advertising effectiveness.

In an embodiment of the invention, the base 11 is equipped with at least two handles 111 on the other surface thereof, and the base 11 is equipped with a plurality of perforations 112 on the other surface thereof. Accordingly, the handles 111 can be applied by a force to move and handle the base body 1 for mounting. In addition, the perforations 112 goes with fixing components (not shown in the drawings) as required to mount the base body 1 on a surface of the wall, a stand or other bracket so that the invention can further meet the needs of practical use.

In an embodiment of the invention, the first light-emitting body 31 is a LED light strip provided annularly on the outer edge of the light-guiding plate 22, and the first light-emitting body 31 is connected to a light source controller 5. Accordingly, the light source form can be set by the light source controller 5 so that the first light-emitting body 31 can emit the light sources with different forms such as the light source of flashing form, the light source of flowing water form, the light source of marquee form or the light source of circulation form according to the advertising film played by the audio and video output unit 4, and thus the first light-emitting body 31 can carry out the demonstration of the light source to increase the visual effects of attracting the attention of consumers for achieving a better advertising effectiveness.

In an embodiment of the invention, the audio and video output unit 4 includes a display 41 and a video player 42 connected to the display 41, and the window areas correspond to the video player 42. Accordingly, the advertising film as desired to play can be pre-stored (or recorded) in the video player 42, and time of playing and other related settings can be set, and thus the display 41 can play the advertising film according to the settings of the video player 42 so that the invention can further meet the needs of practical use.

In addition, The base body 1 may be a circular shape, polygon or geometrical figure, and the reflective film 21, the light-guiding plate 22 and the light-transmission cover plate 23 are provided to be a circular shape, polygon or geometrical figure according to the shape of the base body 1, and the light-transmission cover plate 23 is combined removably with the base 11 or the closed plate 12 by means of screws, threads or magnets (not shown in the drawings), and thus the light-transmission cover plate 23 can be removed according to the needs to change the light-guiding plates with different forms. Accordingly, the invention can further meet the needs of the practical application in visual effects.

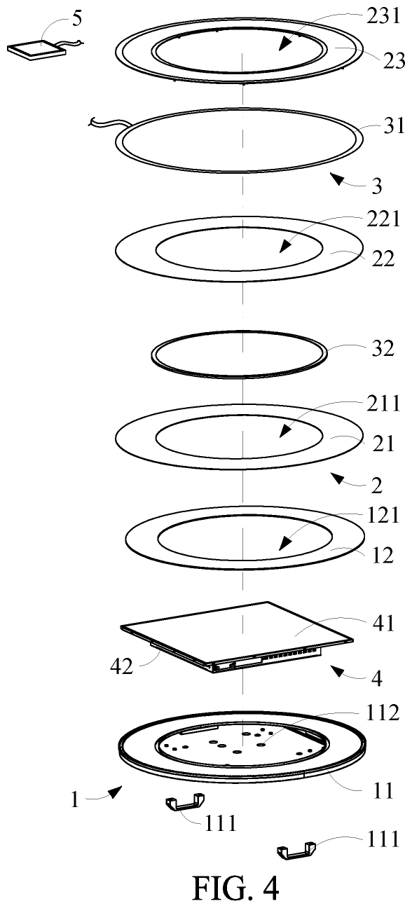

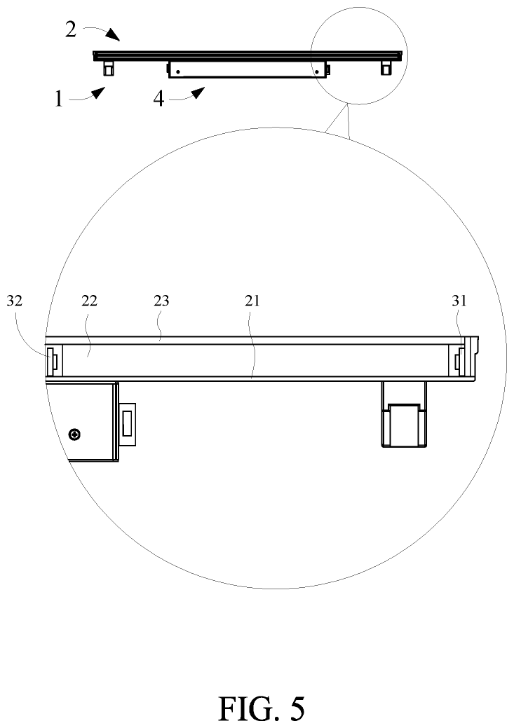

Referring to FIGS. 4 and 5, as shown in the drawings, in an embodiment of the invention, the light-emitting unit 3 is further equipped with a second light-emitting body 32, the second light-emitting body 32 is provided on an inner edge of the light-guiding plate 22, the second light-emitting body 32 is a LED light strip provided annularly on the inner edge of the light-guiding plate 22, and the second light-emitting body 32 is connected to a light source controller 5, wherein the first light-emitting body 31 and the second light-emitting body 32 may connect to the same or different light source controller 5. The invention takes the first light-emitting body 31 and the second light-emitting body 32 connecting to the same light source controller 5 as an embodiment.

Therefore, when the audio and video output unit 4 plays the advertising film, the light sources can simultaneously (or respectively) be emitted by the first light-emitting body 31 and the second light-emitting body 32 of the light-emitting unit 3 according to the light source form set by the light source controller 5 so that the light source of the first light-emitting body 31 is introduced inward from the outer edge of the light-guiding plate 22, the light source of the second light-emitting body 32 is introduced outward from the inner edge of the light-guiding plate 22 so that the light sources of the first light-emitting body 31 and the second light-emitting body 32 can produce a change of mixed light in the same plane, and the light sources of the first light-emitting body 31 and the second light-emitting body 32 are radiated from a direction of the light-transmission cover plate 23 after the light sources are transmitted by the light-guiding plate 22 because of the installation of the reflective film 21, and thus the first light-emitting body 31 and the second light-emitting body 32 can go with the advertising film played by the audio and video output unit 4 to carry out the demonstration of the light sources. Accordingly, the advertising film can be played by the audio and video output unit 4, and the light-emitting unit 3 carries out the demonstration of the light sources in conjunction with the light-guiding unit 2 at the time of playing the advertising film to increase visual effects and attract the attention of consumers for achieving a better advertising effectiveness.

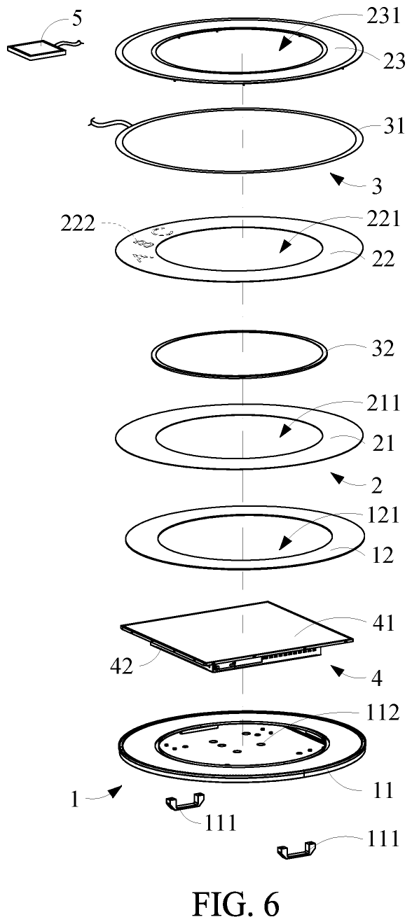

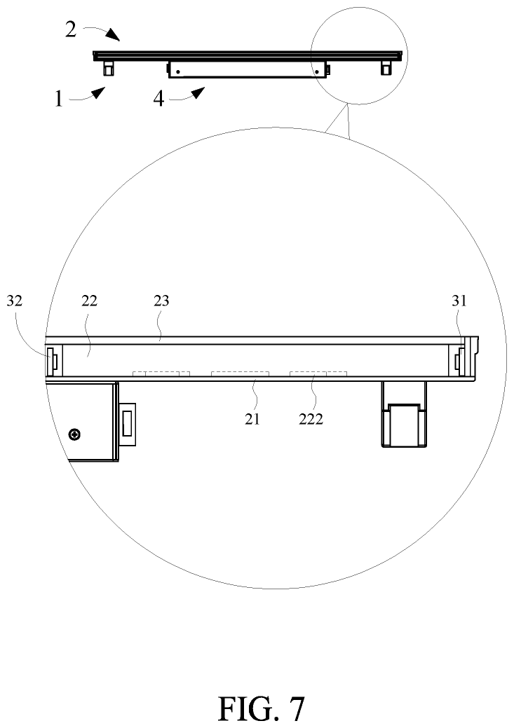

Referring to FIGS. 6 and 7, as shown in the drawings, in an embodiment of the invention, the light-emitting unit 3 is further equipped with a second light-emitting body 32, and the light-guiding plate 22 is equipped with a pattern portion 222 at the bottom, the second light-emitting body 32 is provided on an inner edge of the light-guiding plate 22, the second light-emitting body 32 is a LED light strip provided annularly on the inner edge of the light-guiding plate 22, and the second light-emitting body 32 is connected to a light source controller 5, wherein the first light-emitting body 31 and the second light-emitting body 32 may connect to the same or different light source controller 5. The invention takes the first light-emitting body 31 and the second light-emitting body 32 connecting to the same light source controller 5 as an embodiment. In addition, the pattern portion 222 may be text, numbers, various graphics or a combination thereof.

Therefore, when the audio and video output unit 4 plays the advertising film, the light sources can simultaneously (or respectively) be emitted by the first light-emitting body 31 and the second light-emitting body 32 of the light-emitting unit 3 according to the light source form set by the light source controller 5 so that the light source of the first light-emitting body 31 is introduced inward from the outer edge of the light-guiding plate 22, the light source of the second light-emitting body 32 is introduced outward from the inner edge of the light-guiding plate 22 so that the light sources of the first light-emitting body 31 and the second light-emitting body 32 can produce a change of mixed light in the same plane, and the light sources of the first light-emitting body 31 and the second light-emitting body 32 are radiated from a direction of the light-transmission cover plate 23 to show a pattern of the pattern portion 222 after the light sources are transmitted by the light-guiding plate 22 because of the installation of the reflective film 21, and thus the first light-emitting body 31 and the second light-emitting body 32 can go with the advertising film played by the audio and video output unit 4 to carry out the demonstration of the light sources Accordingly, the advertising film can be played by the audio and video output unit 4, and the light-emitting unit 3 carries out the demonstration of the light sources in conjunction with the light-guiding unit 2 at the time of playing the advertising film to increase visual effects and attract the attention of consumers for achieving a better advertising effectiveness.

Further, in an embodiment of the invention, the reflective film 21 is equipped with a pattern portion (not shown in the drawings) thereon. Accordingly, when the light sources of the first light-emitting body 31 and the second light-emitting body 32 are radiated, the pattern portion of the reflective film 21 can simultaneously or respectively go with the pattern portion 222 of the light-guiding plate 22 to carry out a show in order to increase visual effects and attract the attention of consumers for achieving a better advertising effectiveness.

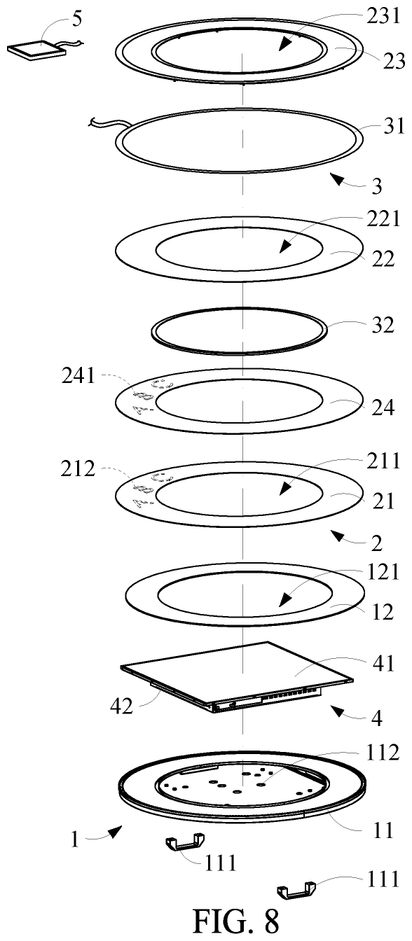

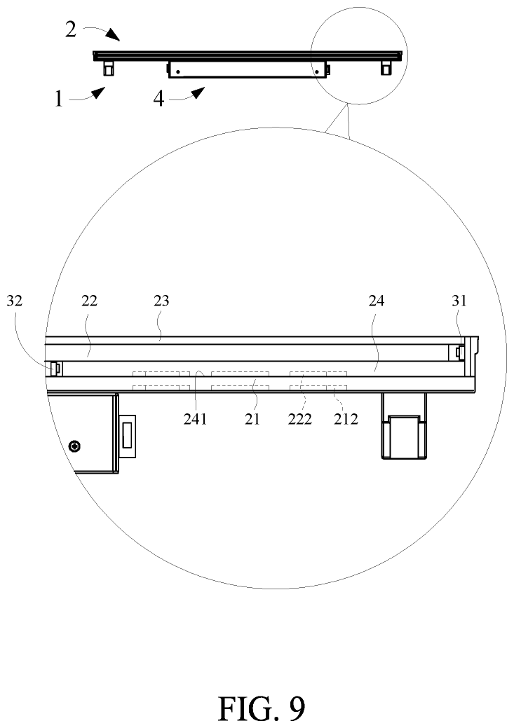

Referring to FIGS. 8 and 9, as shown in the drawings, in an embodiment of the invention, the light-emitting unit 3 is further equipped with a second light-emitting body 32, and another light-guiding plate 24 is provided between the light-guiding plate 22 and the reflective film 21, the another light-guiding plate 24 is equipped with a pattern portion 241 at the bottom, the second light-emitting body 32 is provided on an inner edge of the another light-guiding plate 24, the second light-emitting body 32 is a LED light strip provided annularly on the inner edge of the another light-guiding plate 24, and the second light-emitting body 32 is connected to a light source controller 5, wherein the first light-emitting body 31 and the second light-emitting body 32 may connect to the same or different light source controller 5. The invention takes the first light-emitting body 31 and the second light-emitting body 32 connecting to the same light source controller 5 as an embodiment.

Therefore, when the audio and video output unit 4 plays the advertising film, the light sources can simultaneously (or respectively) be emitted by the first light-emitting body 31 and the second light-emitting body 32 of the light-emitting unit 3 according to the light source form set by the light source controller 5 so that the light source of the first light-emitting body 31 is introduced inward from the outer edge of the light-guiding plate 22, the light source of the second light-emitting body 32 is introduced outward from the inner edge of the another light-guiding plate 24 so that the light sources of the first light-emitting body 31 and the second light-emitting body 32 can produce a change of mixed light in the different plane, and the light sources of the first light-emitting body 31 and the second light-emitting body 32 are radiated from a direction of the light-transmission cover plate 23 to show a pattern of the pattern portion 241 after the light sources are transmitted by the light-guiding plate 22 because of the installation of the reflective film 21, and thus the first light-emitting body 31 and the second light-emitting body 32 can go with the advertising film played by the audio and video output unit 4 to carry out the demonstration of the light sources. Accordingly, the advertising film can be played by the audio and video output unit 4, and the light-emitting unit 3 carries out the demonstration of the light sources in conjunction with the light-guiding unit 2 at the time of playing the advertising film to increase visual effects and attract the attention of consumers for achieving a better advertising effectiveness.

Further, in an embodiment of the invention, the reflective film 21 may also be equipped with a pattern portion 212 according to a need. Accordingly, the light source of the first light-emitting body 31 is introduced inward from the outer edge of the light-guiding plate 22, the light source of the second light-emitting body 32 is introduced outward from the inner edge of the another light-guiding plate 24 so that the light sources of the first light-emitting body 31 and the second light-emitting body 32 can produce a change of mixed light in the different plane, and the light sources of the first light-emitting body 31 and the second light-emitting body 32 are radiated from a direction of the light-transmission cover plate 23 to show patterns of the pattern portions 212, 241 after the light sources are transmitted by the light-guiding plate 22 because of the installation of the reflective film 21 to increase visual effects and attract the attention of consumers for achieving a better advertising effectiveness.

While the present disclosure has been described by means of specific embodiments, numerous modifications and variations could be made thereto by those skilled in the art without departing from the scope and spirit of the present disclosure set forth in the claims.

What is claimed is:

1. An advertising display device, comprising:
a base body, including a base and a closed plate provided on a surface of the base;
a light-guiding unit, provided on the closed plate, and the light-guiding unit includes a reflective film provided on a surface of the closed plate, a light-guiding plate provided on a surface of the reflective film, and a light-transmission cover plate provided on a surface of the light-guiding plate;
a light-emitting unit, including at least one first light-emitting body provided on an outer edge of the light-guiding plate; and
an audio and video output unit, provided between the base and the closed plate, and the closed plate, the reflective film, the light-guiding plate and the light-transmission cover plate respectively have a window area corresponding to the audio and video output unit.

2. The advertising display device according to claim 1, wherein the base is equipped with at least two handles on the other surface thereof, and the base is equipped with a plurality of perforations on the other surface thereof.

3. The advertising display device according to claim 1, wherein the light-emitting unit is further equipped with a second light-emitting body, and the second light-emitting body is provided on an inner edge of the light-guiding plate.

4. The advertising display device according to claim 1, wherein the light-emitting unit is further equipped with a second light-emitting body, the light-guiding plate is equipped with a pattern portion at the bottom, and the second light-emitting body is provided on an inner edge of the light-guiding plate.

5. The advertising display device according to claim 1, wherein the light-emitting unit is further equipped with a second light-emitting body, and another light-guiding plate is provided between the light-guiding plate and the reflective film, the another light-guiding plate is equipped with a pattern portion at the bottom, the second light-emitting body is provided on an inner edge of the another light-guiding plate.

6. The advertising display device according to claim 1, wherein the audio and video output unit includes a display and a video player connected to the display, and the window areas correspond to the video player.

7. The advertising display device according to claim 1, wherein the first light-emitting body is a LED light strip provided annularly on the outer edge of the light-guiding plate, and the first light-emitting body is connected to a light source controller.

8. The advertising display device according to claim 3, wherein the second light-emitting body is a LED light strip provided annularly on the inner edge of the light-guiding plate, and the second light-emitting body is connected to a light source controller.

9. The advertising display device according to claim 4, wherein the second light-emitting body is a LED light strip provided annularly on the inner edge of the light-guiding plate, and the second light-emitting body is connected to a light source controller.

10. The advertising display device according to claim 5, wherein the second light-emitting body is a LED light strip provided annularly on the inner edge of the light-guiding plate, and the second light-emitting body is connected to a light source controller.

11. The advertising display device according to claim 1, wherein the reflective film is equipped with a pattern portion thereon.
